(19) United States
(12) Patent Application Publication
(10) Pub. No.: US 2013/0187624 A1
(43) Pub. Date: Jul. 25, 2013

(54) SEMICONDUCTOR INTEGRATED CIRCUIT DEVICE AND DC-DC CONVERTER

(71) Applicant: Kenichi WAKASUGI, Yokohama-shi (JP)

(72) Inventor: Kenichi WAKASUGI, Yokohama-shi (JP)

(73) Assignee: Kabushiki Kaisha Toshiba, Tokyo (JP)

(21) Appl. No.: 13/549,943

(22) Filed: Jul. 16, 2012

(30) Foreign Application Priority Data
Jan. 24, 2012 (JP) 2012-012096

(51) Int. Cl. G05F 1/46

(52) U.S. Cl. 323/282

(57) ABSTRACT

According to one embodiment, a semiconductor integrated circuit device for a DC-DC converter is configured to convert an input voltage to an output voltage by controlling a voltage supplied to a load according to a Pulse Width Modulation (PWM) signal, and to output the output voltage from an output terminal. The device includes an error voltage generator, a phase compensating module, a controller, and an error voltage adjuster. The error voltage generator is configured to generate an error voltage indicative of a difference between a feedback voltage corresponding to the output voltage and a predetermined reference voltage. The controller is configured to generate the PWM signal whose duty ratio depends on the error voltage and on a current flowing through the load connected to the output terminal. The error voltage adjuster is configured to adjust the error voltage based on a gradient of the feedback voltage.

### CROSS REFERENCE TO RELATED APPLICATIONS

This application is based upon and claims the benefit of priority from the prior Japanese Patent Application No. 2012-12096, filed on Jan. 24, 2012, the entire contents of which are incorporated herein by reference.

### FIELD

Embodiments described herein relate generally to a semiconductor integrated circuit device and a dc-dc converter.

### BACKGROUND

A DC-DC converter converts an input DC voltage into an output DC voltage different from the input DC voltage and supplies the output DC voltage to a load. Usually it is possible to supply a constant output DC voltage to the load by a feedback operation even when the load varies somewhat. However, there is a problem that, if the load varies rapidly, the output DC voltage also varies largely.

### BRIEF DESCRIPTION OF THE DRAWINGS

FIG. 1 is FIG. 1 is a circuit diagram of a DC-DC converter 100 according to a first embodiment.

FIGS. 2A and 2B are voltage waveform charts schematically showing an operation of the controller 3.

FIG. 3 is a waveform chart schematically showing a relationship among the PWM signals Vpwmp and Vpwmn, the current IL, and the sense voltage Vsens.

FIG. 4 is a waveform chart showing an outline of the operation of the DC-DC converter 100 when the load Rload varies largely.

FIG. 5 is a waveform chart showing a detailed operation of the DC-DC converter 100.

FIG. 6 is a circuit diagram of a DC-DC converter 101 according to the second embodiment.

FIG. 7 is a waveform chart showing a detailed operation of the DC-DC converter 101 shown in FIG. 6.

FIG. 8 is a circuit diagram of a DC-DC converter 200 according to the third embodiment.

### DETAILED DESCRIPTION

In general, according to one embodiment, a semiconductor integrated circuit device for a DC-DC converter is configured to convert an input voltage to an output voltage by controlling a voltage supplied to a load according to a Pulse Width Modulation (PWM) signal, and to output the output voltage from an output terminal. The device includes an error voltage generator, a phase compensating module, a controller, and an error voltage adjuster. The error voltage generator is configured to generate an error voltage indicative of a difference between a feedback voltage corresponding to the output voltage and a predetermined reference voltage. The phase compensating module is configured to compensate a phase of the error voltage. The controller is configured to generate the PWM signal whose duty ratio depends on the error voltage and on a current flowing through the load connected to the output terminal. The error voltage adjuster is configured to adjust the error voltage based on a gradient of the feedback voltage.

Embodiments will now be explained with reference to the accompanying drawings.

### First Embodiment

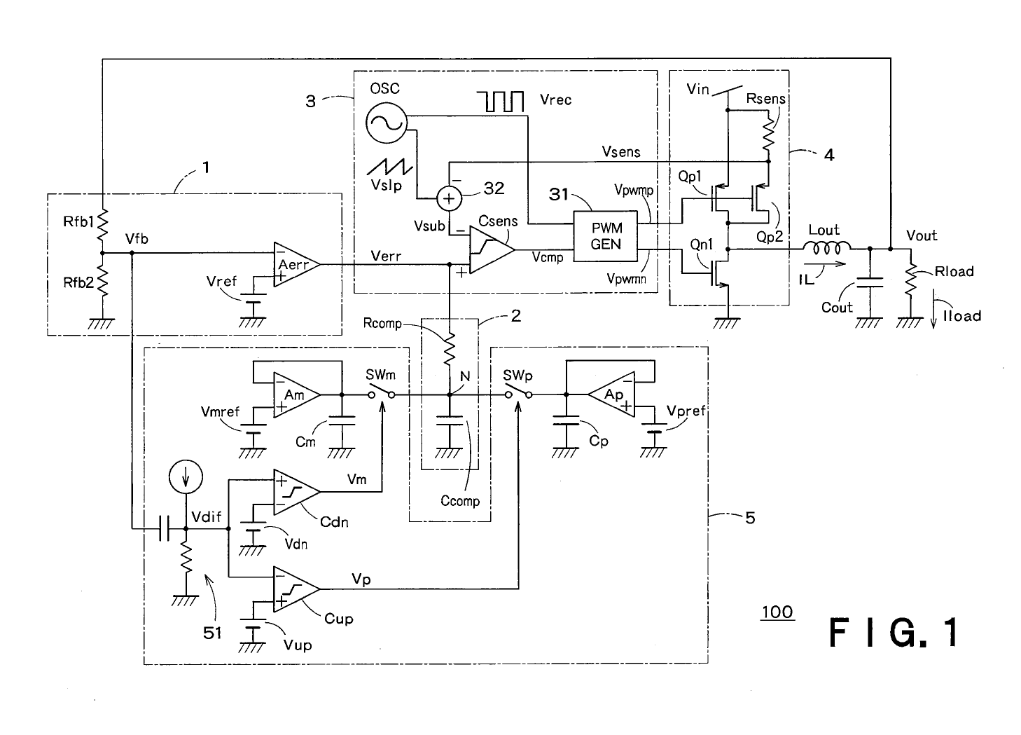

FIG. 1 is a circuit diagram of a DC-DC converter 100 according to a first embodiment. The DC-DC converter 100 in FIG. 1 is a step-down DC-DC converter which generates a desired output voltage Vout lower than an input voltage Vin and supplies the output voltage Vout to a load Rload.

The DC-DC converter 100 includes an error voltage generator 1, a phase compensating module 2, a controller 3, a switching module 4, an error voltage adjuster 5, an inductor Lout, and a capacitor Cout. The output voltage Vout is outputted from an output terminal of the DC-DC converter 100 and supplied to the load Rload.

The error voltage generator 1 generates an error voltage Verr on the basis of the output voltage Vout and a predetermined reference voltage Vref. More specifically, the error voltage generator 1 includes feedback resistors Rfb1 and Rfb2 serially connected between the output terminal of the DC-DC converter 100 and an earth terminal, and further includes an error amplifier Aerr. The reference voltage Vref is inputted into the positive input terminal of the error amplifier Aerr and a feedback voltage Vfb obtained by dividing the output voltage Vout by the resistors Rfb1 and Rfb2 is inputted into the negative input terminal thereof. The error amplifier Aerr amplifies a difference between the reference voltage Vref and the feedback voltage Vfb to output the error voltage Verr. The reference voltage Vref is set according to a value of a necessary output voltage Vout. The error voltage Verr can be adjusted by the error voltage adjuster 5 as described later.

The phase compensating module 2 includes a phase compensating resistor Rcomp and a phase compensating capacitor Rcomp which are serially connected between the output terminal of the error amplifier Aerr and an earth terminal. The phase compensating module 2 compensates a phase of the error voltage Verr by a time constant according to the resistance of the resistor Rcomp, the capacity of the capacitor Ccomp, and the amplification factor of the error amplifier Aerr. Thereby, it is possible to prevent the error voltage Verr from being fixed to a power supply voltage or an earth voltage.

By setting the time constant of the phase compensating module 2 to be small, it is possible to prevent the output voltage Vout from changing rapidly. However, in that case, an unstable state may occur, such as the output voltage oscillates. Therefore, in the present embodiment, it is intended to stably prevent the rapid change of the output voltage Vout without setting the time constant of the phase compensating module 2 so small.

The controller 3 generates PWM (Pulse Width Modulation) signals Vpwmp and Vpwmn whose duty ratios are determined on the basis of the error voltage Verr. More specifically, the controller 3 includes an oscillator OSC, a comparator Csens, a PWM signal generator (PWM GEN) 31, and a subtractor 32.

The oscillator OSC generates a rectangular wave signal Vrec having a constant period and supplies the rectangular wave signal Vrec to the PWM signal generator 31. Further, the oscillator OSC generates a saw-tooth wave voltage Vslp which has the same period as that of the rectangular wave signal Vrec and is reset in synchronization with falling edges of the rectangular wave signal Vrec, and the oscillator OSC supplies the saw-tooth wave voltage Vslp to the subtractor 32. The subtractor 32 generates a voltage Vsub (=Vslp−Vsens) obtained by subtracting a sense voltage Vsens described later from the saw-tooth wave voltage Vslp. However, when the PWM signal Vpwmp is HIGH, the subtractor 32 sets the voltage Vsub to 0 V.

The error voltage Verr is inputted into the positive input terminal of the comparator Csens and the voltage Vsub is inputted into the negative input terminal thereof. When the error voltage Verr is higher than the voltage Vsub, the comparator Csens outputs HIGH. However, when the voltage Vsub reaches the error voltage Verr, the comparator Csens outputs LOW and supplies the LOW signal to the PWM signal generator 31 as a comparison signal Vcmp.

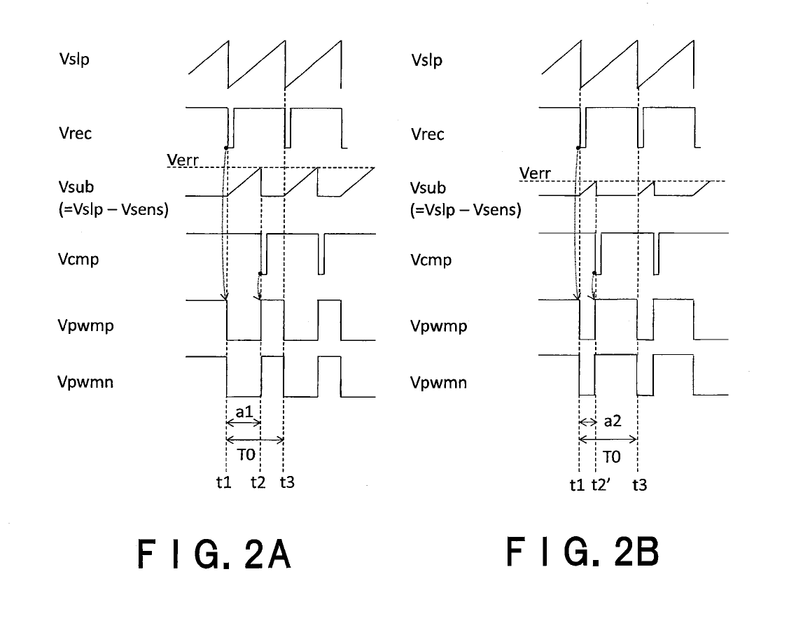

FIG. 2 is a voltage waveform chart schematically showing an operation of the controller 3. In FIG. 2, the horizontal axes indicate time and the vertical axes indicate the saw-tooth wave voltage Vslp, the rectangular wave signal Vrec, the voltage Vsub, the comparison signal Vcmp, the PWM signals Vpwmp and Vpwmn in order from above. FIG. 2 shows an example in which the sense voltage Vsens and the error voltage Verr are constant. FIG. 2B shows an example in which the error voltage Verr is lower than that in FIG. 2A.

Firstly, an operation of the PWM signal generator 31 will be described with reference to FIG. 2A. The PWM signal generator 31 performs an operation similar to an SR flip-flop, whose set terminal is inputted with the rectangular wave signal Vrec and whose reset terminal is inputted with the comparison signal Vcmp. Specifically, the PWM signal generator 31 sets the PWM signals Vpwmp and Vpwmn to LOW in synchronization with a falling edge of the rectangular wave signal Vrec (time t1). The PWM signal generator 31 sets the PWM signals Vpwmp and Vpwmn to HIGH in synchronization with a falling edge of the comparison signal Vcmp (time t2).

Next, operations of the subtractor 32 and the comparator Csens will be described. After time t1, when the voltage Vsub rises and reaches the error voltage Verr at time t2, the comparator Csens sets the comparison signal Vcmp to LOW. Accordingly, the PWM signal Vpwmp is set to HIGH as described above, so that the subtractor 32 sets the voltage Vsub to 0 V after time t2. Thereafter, when the PWM signal Vpwmp is set to LOW at time t3, the voltage Vsub rises following the rise of the saw-tooth wave voltage Vslp.

Here, a ratio of a time period in which the PWM signals Vpwmp and Vpwmn are LOW with respect to a period T0 of the rectangular wave signal Vrec is referred to as a duty ratio. In FIG. 2A, the duty ratio is a1/T0. On the other hand, in FIG. 2B, the error voltage Verr is lower, so that the voltage Vsub reaches the error voltage Verr in a short time. Therefore, the duty ratio is a2/T0 which is smaller than that in FIG. 2A. In this way, the lower the error voltage Verr is, the smaller the duty ratio becomes.

Let us return to FIG. 1. The switching module 4 supplies a current IL from an input power terminal to the inductor Lout. More specifically, the switching module 4 includes a PMOS transistor Qp1 and an NMOS transistor Qn1 which are cascaded between the input power terminal that supplies an input voltage Vin and an earth terminal, and further includes a resistor Rsens and a PMOS transistor Qp2 which are connected in parallel with the transistor Qp1.

When the PWM signals Vpwmp and Vpwmn are LOW, the transistor Qp1 turns on and the switching module 4 outputs the input voltage Vin. When the PWM signals Vpwmp and Vpwmn are HIGH, the transistor Qn1 turns on and the switching module 4 outputs the earth voltage. For example, transistor Qp2 is formed to have one-thousandth the size of the transistor Qp1, so that the transistor Qp2 allows one-thousandth the amount of current flowing through the transistor Qp1 to flow. The sense voltage Vsens is generated by this current and the resistor Rsens.

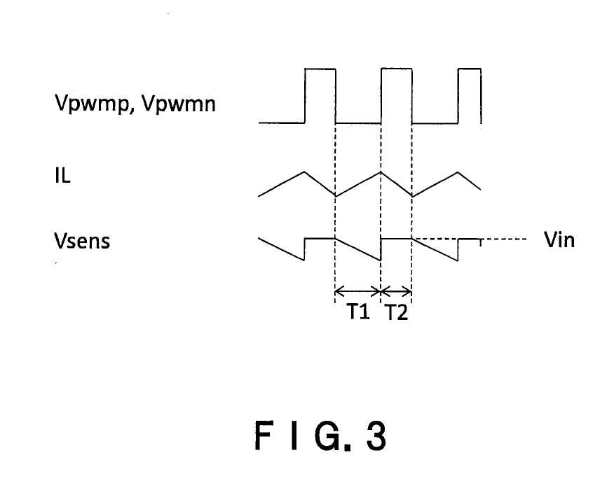

FIG. 3 is a waveform chart schematically showing a relationship among the PWM signals Vpwmp and Vpwmn, the current IL, and the sense voltage Vsens. As shown in FIG. 3, in the time period T1, the PWM signals Vpwmp and Vpwmn are LOW, so that the transistors Qp1 and Qp2 turn on. Therefore, the current IL increases gradually. Thus, the voltage drop at the resistor Rsens become larger. As a result, the sense voltage Vsens decreases gradually.

On the other hand, in the time period T2, the PWM signals Vpwmp and Vpwmn are HIGH, so that the transistors Qp1 and Qp2 turn off. Therefore, almost no current flows through the resistor Rsens. Thus, the sense voltage Vsens is near the input voltage Vin. As described above, the sense voltage Vsens corresponds to the current IL flowing through the inductor Lout. As known from FIG. 3, the larger the duty ratio of the PWM signals Vpwmp and Vpwmn, the longer the time period in which the transistor Qp1 is on, so that the value of the current IL increases.

Let us return to FIG. 1. The inductor Lout and the capacitor Cout are serially connected between the output terminal of the switching module 4 and an earth terminal. The output voltage Vout is outputted from the connection nodes thereof and supplied to the load Rload. A voltage difference between the voltage outputted from the switching module 4 and the output voltage Vout is applied to the inductor Lout. Setting the load Rload side of the inductor Lout as a basis, the voltage reference is “input voltage Vin−output voltage Vout” when the transistor Qp1 is on, and the voltage reference is “earth voltage−output voltage Vout” when the transistor Qn1 is on. Therefore, a positive voltage and a negative voltage are alternately applied to the inductor Lout, and the current IL having a triangular waveform as shown in FIG. 3 flows through the inductor Lout.

When the current flowing through the inductor Lout and the current flowing through the load Rload are balanced, the current flowing through the capacitor Cout is equivalent to 0, and then, the output voltage Vout is in a stable state.

The error voltage adjuster 5, which is one of the features of the present embodiment, adjusts the error voltage Verr on the basis of the slope of the output voltage Vout. More specifically, the error voltage adjuster 5 includes a differential detector 51, comparators Cdn and Cup, amplifiers Ap and Am, capacitors Cp and Cm, and switches SWp and SWn.

The differential detector 51 is, for example, a high pass filter including a current source, a capacitor, and a resistor. The feedback voltage Vfb is inputted into one terminal of the capacitor and a differential voltage Vdif is outputted from a connection node between the other terminal of the capacitor and the resistor.

The comparator Cup, the amplifier Ap, the capacitor Cp, and the switch SWp form a voltage step-up module which raises the error voltage Verr. A threshold voltage Vup is inputted into the positive input terminal of the comparator Cup and the differential voltage Vdif is inputted into the negative input terminal thereof. When the differential voltage Vdif is higher than the threshold voltage Vup, the comparator Cup outputs LOW as a voltage step-up signal Vp. When the differential voltage Vdif is lower than the threshold voltage Vup, the comparator Cup outputs HIGH as a voltage step-up signal Vp. In other words, the comparator Cup sets the voltage step-up signal Vp to HIGH when the feedback voltage Vfb drops rapidly.

The switch SWp turns off when the voltage step-up signal Vp outputted from the comparator Cup is LOW. The switch SWp turns on when the voltage step-up signal Vp is HIGH. A constant voltage Vpref is inputted into the positive input terminal of the amplifier Ap and the negative input terminal is short-circuited to the output terminal. When the switch SWp is off, the amplifier Ap supplies the voltage Vpref to the capacitor Cp.

Similarly, the comparator Cdn, the amplifier Am, the capacitor Cm, and the switch SWm form a voltage step-down module which drops the error voltage Verr. The differential voltage Vdif is inputted into the positive input terminal of the comparator Cdn and a threshold voltage Vdn is inputted into the negative input terminal thereof. Here, the threshold voltage Vdn is higher than the threshold voltage Vup. When the differential voltage Vdif is higher than the threshold voltage Vdn, the comparator Cdn outputs HIGH as a voltage step-down signal Vm. When the differential voltage Vdif is lower than the threshold voltage Vdn, the comparator Cdn outputs LOW as a voltage step-down signal Vm. In other words, the comparator Cdn sets the voltage step-down signal Vm to HIGH when the feedback voltage Vfb rises rapidly.

The switch SWm turns off when the voltage step-down signal Vm outputted from the comparator Cdn is LOW. The switch SWm turns on when the voltage step-down signal Vm is HIGH. A constant voltage Vmref is inputted into the positive input terminal of the amplifier Am and the negative input terminal is short-circuited to the output terminal. When the switch SWm is off, the amplifier Am supplies the voltage Vmref to the capacitor Cm.

The DC-DC converter 100 in FIG. 1 described above may be mounted as one semiconductor integrated circuit device or may be mounted on a PCB (Printed Circuit Board) substrate by using discrete components. Or, at least a part of the DC-DC converter 100, for example, the inductor Lout and the capacitor Cout in FIG. 1, are mounted as discrete components and the other components may be mounted as one semiconductor integrated circuit device. Or, the inductor Lout, the capacitor Cout, and the switching module 4 are mounted as discrete components and the other components may be mounted as one semiconductor integrated circuit device.

An outline of the operation of the DC-DC converter 100 is as follows. When a resistance of the load Rload slightly increases, the current flowing through the load Rload decreases. Then, the output voltage Vout becomes higher than a desired voltage, and the feedback voltage Vfb rises. Therefore, the error voltage Verr lowers. As a result, as described in FIG. 2, the duty ratio of the PWM signals Vpwmp and Vpwmn decreases and the time period in which the transistor Qp1 is on decreases. Therefore, the output voltage Vout lowers and stabilizes at a desired voltage.

On the other hand, when the resistance of the load Rload slightly decreases, the current flowing through the load Rload increases. Then, the output voltage Vout becomes lower than the desired voltage, and the feedback voltage Vfb lowers. Therefore, the error voltage Verr rises. As a result, as described in FIG. 2, the duty ratio of the PWM signals Vpwmp and Vpwmn increases and the time period in which the transistor Qp is on increases. Therefore, the output voltage Vout rises and stabilizes at the desired voltage. By the feedback operation as described above, the DC-DC converter 100 can generate a constant output voltage Vout even if the load Rload varies somewhat.

Next, a case in which the load Rload varies largely will be described. In the description below, it is assumed that the load Rload is either in a high load state where a large current IloadL flows through the load Rload or in a low load state where a small current IloadS flows through the load Rload.

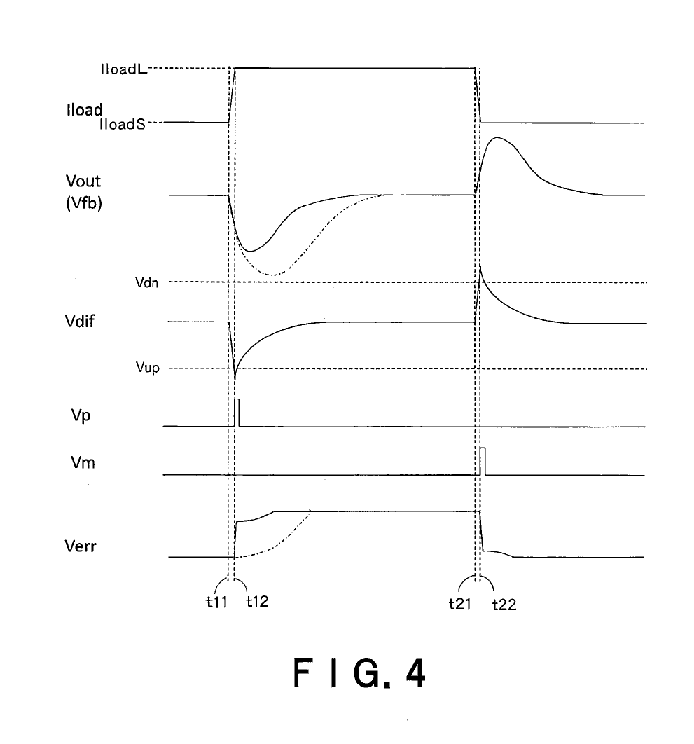

FIG. 4 is a waveform chart showing an outline of the operation of the DC-DC converter 100 when the load Rload varies largely. The waveforms shown by solid lines indicate, from the above, the current Iload flowing through the load Rload, the output voltage Vout supplied to the load Rload (and the feedback voltage Vfb proportional thereto), the differential voltage Vdif outputted by the differential detector 51, the voltage step-up signal Vp and the voltage step-down signal Vm which are outputted from the comparators Cup and Cdn, respectively, and the error voltage Verr.

When the load Rload changes largely from the low load state to the high load state at time t11, the load current Iload increases rapidly from IloadS to IloadL. As a result, the DC-DC converter 100 cannot supply sufficient charge to the output terminal, so that the output voltage Vout drops temporarily. Thereby, the feedback voltage Vfb also drops.

When the feedback voltage Vfb drops and the (negative) slope of the feedback voltage Vfb increases, the differential voltage Vdif also drops. When the differential voltage Vdif drops below the threshold voltage Vup at time t12, the comparator Cup sets the voltage step-up signal Vp to HIGH. Thereby, the switch SWp turns on.

At this time, the charge Qp0=Cp*Vpref accumulated in the capacitor Cp shown in FIG. 1 before time t12, is redistributed to the capacitor Cp and the capacitor Ccomp. If a voltage of a connection node N between the capacitor Ccomp and the resistor Rcomp immediately before time t12 is V0, a voltage V1 of the connection node N at time t12 is represented by the equation (1) below.

V1=(Ccomp*V0+Cp*Vpref)/(Ccomp+Cp) (1)

In the above equation (1), the capacitors Cp and Ccomp and the voltage Vpref are adjusted in advance so that the voltage V1 is higher than the voltage V0. More specifically, the values of the capacitors Cp and Ccomp and the voltage Vpref are adjusted in advance so that the voltage V1 satisfies the equation (2) below.

V1=IloadL/gm (2)

Here, gm is a ratio of the error voltage Verr inputted into the controller 3 and an average current IL flowing through the coil Lout.

When the voltage of the connection node N is raised at time t12, the error voltage Verr is also raised rapidly through the resistor Rcomp. As a result, the duty ratio of the PWM signals Vpwmp and Vpwmn increases and the time period in which the transistor Qp is on increases. Therefore, the output voltage Vout rises rapidly and returns to the original value observed before time t11.

FIG. 4 shows a waveform chart of the output voltage Vout and the error voltage Verr when the error voltage adjuster 5 is not provided to the DC-DC converter 100 by dashed-dotted lines. If the error voltage adjuster 5 is not provided, the error voltage Verr rises slowly after time t12. Therefore, the time period in which the output voltage Vout returns to the original value observed before time t11 increases.

On the other hand, in the present embodiment, as shown by the solid lines in FIG. 4, when the output voltage Vout drops rapidly, the error voltage adjuster 5 raises the error voltage Verr. Therefore, the output voltage Vout returns to the original value observed before time t11 in a short time.

On the other hand, when the load Rload changes largely from the high load state to the low load state at time t21, the load current Iload decreases rapidly from IloadL to IloadS. As a result, the DC-DC converter 100 supplies excess charge to the output terminal, so that the output voltage Vout rises temporarily.

In this case, the comparator Cdn operates at time t22 and drops the error voltage Verr rapidly. As a result, the output voltage Vout returns to the original value observed before time t21 in a short time. A voltage V2 of the connection node N at this time is represented by the equation (3) below.

V2=(Ccomp*V0+Cm*Vmref)/(Ccomp+Cm) (3)

The values of the capacitors Cm and Ccomp and the voltage Vmref may be adjusted in advance so that the voltage V2 satisfies the equation (4) below.

V2=IloadS/gm (4)

Hereinafter, the operation of the DC-DC converter 100 will be described in more detail.

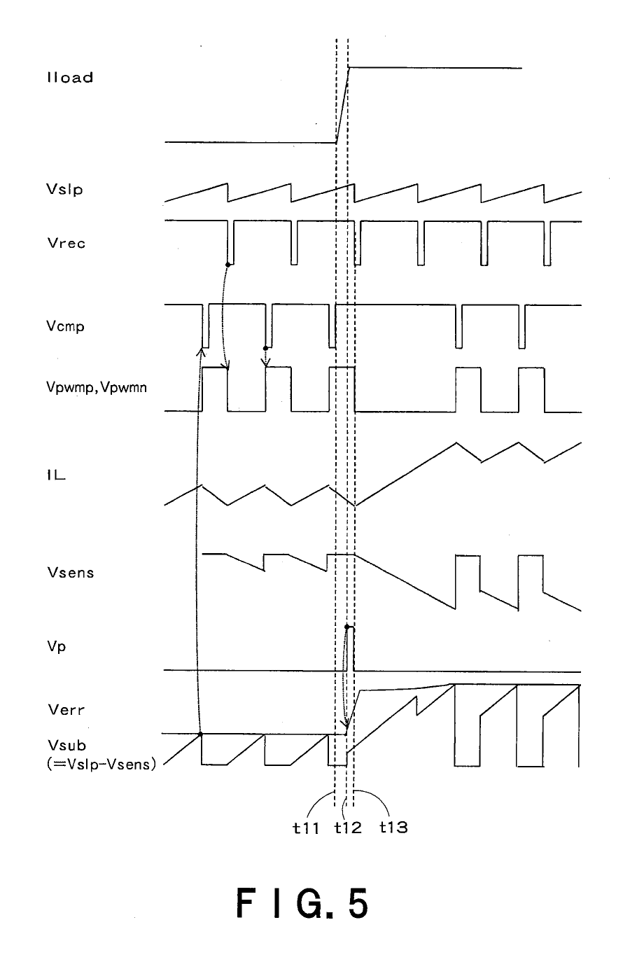

FIG. 5 is a waveform chart showing a detailed operation of the DC-DC converter 100. FIG. 5 is an enlarged waveform chart of a portion around the time t11 to the time t12 in FIG. 4. The waveforms are, from the above, the current Iload, the saw-tooth wave voltage Vslp, the rectangular wave signal Vrec, the comparison signal Vcmp, the PWM signals Vpwmp and Vpwmn, the current IL, the sense voltage Vsens, the voltage step-up signal Vp, the error voltage Verr, and the voltage Vsub.

Because the operation before time t11 is the same as that shown in FIGS. 2 and 3, the description thereof will be omitted.

At time t11, the load current Iload increases rapidly. Subsequently, when the voltage step-up signal Vp rises at time t12, the error voltage Verr is raised as described above. Thereafter, when the rectangular wave signal Vrec rises at time t13, the PWM signal generator 31 sets the PWM signals Vpwmp and Vpwmn to LOW in synchronization with the rise of the rectangular wave signal Vrec. Thereby, the transistor Qp1 turns on, and, after time t13, as the current IL flowing through the inductor Lout increases, the sense voltage Vsens decreases.

When the sense voltage Vsens decreases, the voltage Vsub increases. However, the voltage Vsub does not reach the error voltage Verr in a short time because the error voltage Verr is raised. Therefore, the comparison signal Vcomp is still HIGH, and the PWM signals Vpwmp and Vpwmn are still LOW for a while. When the PWM signals Vpwmp and Vpwmn are LOW, the transistor Qp1 is still on, and thus, the current IL flowing through the coil Lout increases rapidly. Thereby, the output voltage Vout can return to the original value observed before the time t11 in a short time.

The operation principle where the load Rload around time t21 to time t22 decreases rapidly is similar to that described above. Therefore, the detailed description will be omitted.

In this way, in the first embodiment, when the output voltage Vout changes largely due to the variation of the load Rload, the change is detected and the error voltage Verr is adjusted. Specifically, when the output voltage Vout decreases rapidly, the error voltage Verr is raised, and when the output voltage Vout increases rapidly, the error voltage Verr is dropped. Therefore, it is possible to suppress overshoot and quickly return the output voltage Vout to a desired value observed before the load Rload varies. As a result, it is possible to stably supply the output voltage to the load.

### Second Embodiment

In a second embodiment, the error voltage adjuster 5 also controls the PWM signals Vpwmp and Vpwmn.

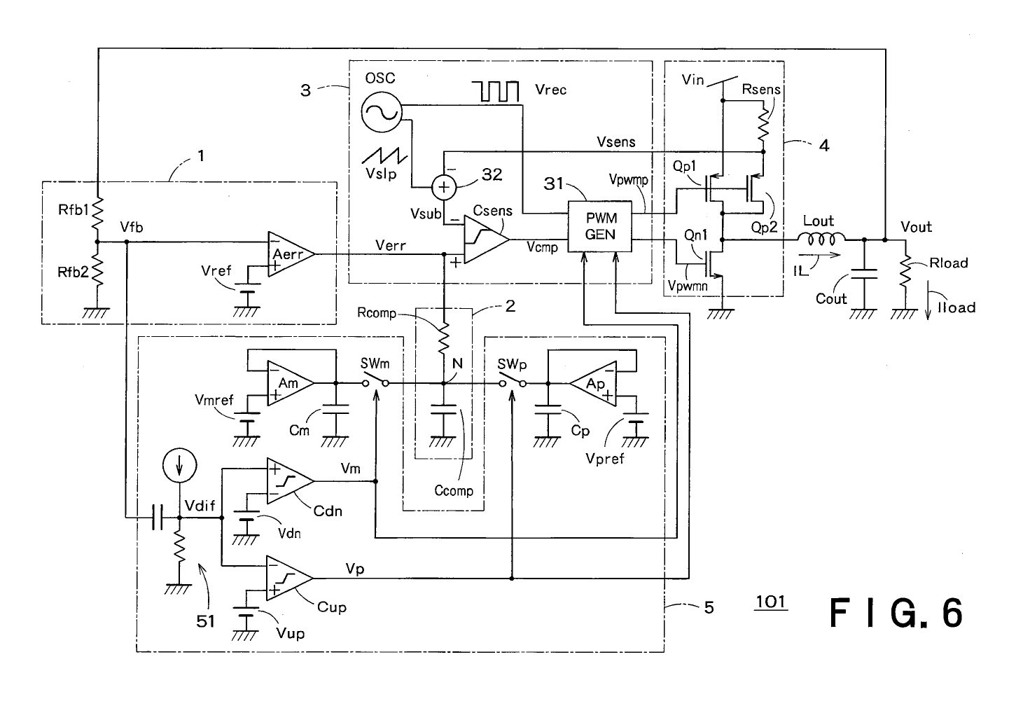

FIG. 6 is a circuit diagram of a DC-DC converter 101 according to the second embodiment. In FIG. 6, the same reference numerals and symbols are given to the same elements as those shown in FIG. 1. Hereinafter, the difference will be mainly described.

In FIG. 6, the PWM signal generator 31 sets the PWM signals Vpwmp and Vpwmn according to the voltage step-up signal Vp outputted by the comparator Cup of the error voltage adjuster 5. More specifically, when the voltage step-up signal Vp rises, the PWM signal generator 31 sets the PWM signals Vpwmp and Vpwmn to LOW regardless of the values of the signals Vrec and Vcmp. Thereby, the transistor Qp1 turns on and the current IL flowing through the inductor Lout increases, and the output voltage Vout rises.

The PWM signal generator 31 also sets the PWM signals Vpwmp and Vpwmn according to the voltage step-down signal Vm outputted by the comparator Cdn of the error voltage adjuster 5. More specifically, when the voltage step-down signal Vm rises, the PWM signal generator 31 sets the PWM signals Vpwmp and Vpwmn to HIGH regardless of the values of the signals Vrec and Vcmp. Thereby, the transistor Qn1 turns on and the current IL flowing through the inductor Lout decreases, and the output voltage Vout lowers.

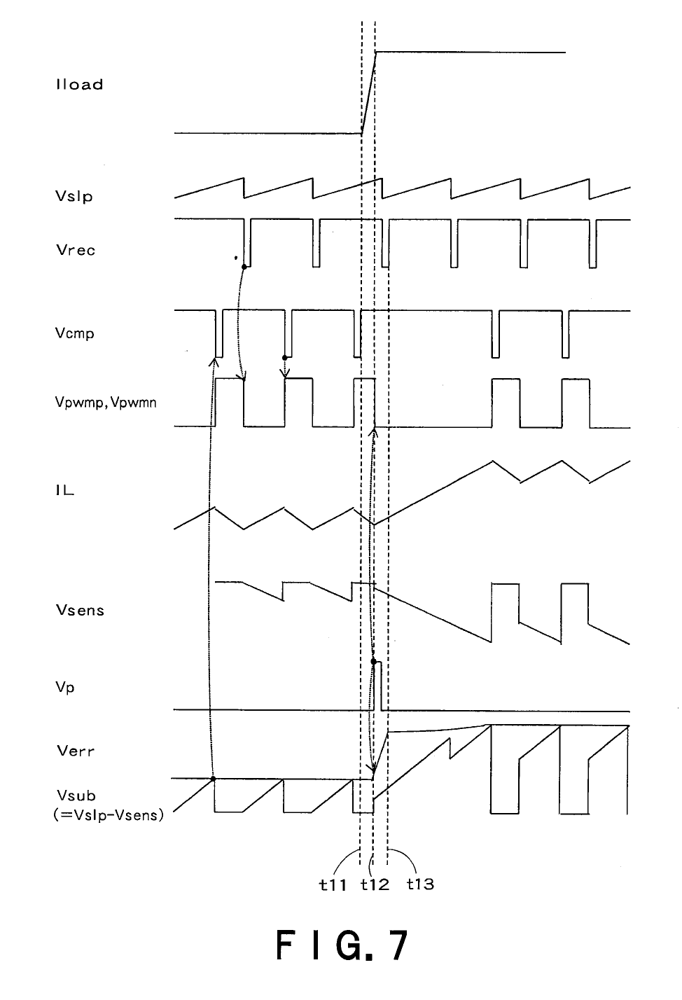

FIG. 7 is a waveform chart showing a detailed operation of the DC-DC converter 101 shown in FIG. 6. FIG. 7 corresponds to FIG. 5. Hereinafter, the difference from FIG. 5 will be mainly described.

When the voltage step-up signal Vp rises at time t12, the error voltage adjuster 5 raises the error voltage Verr similar to FIG. 5. In addition, at time t12, the PWM signal generator 31 sets the PWM signals Vpwmp and Vpwmn to LOW. Thereby, the transistor Qp1 turns on, and, after time t12, as the current IL flowing through the inductor Lout increases, the sense voltage Vsens decreases.

In FIG. 7, the PWM signals Vpwmp and Vpwmn are set to LOW at time t12 which is earlier than time t13. Therefore, in FIG. 7, the PWM signals Vpwmp and Vpwmn are set to LOW earlier than the PWM signals in FIG. 5. As a result, the current IL flowing through the inductor Lout increases earlier than that in FIG. 5. Therefore, the output voltage Vout can return to the original value observed before the load Rload varies earlier than the output voltage Vout in FIG. 5.

Although FIG. 7 is a waveform chart when the load Rload increases, the operation principle where the load Rload decreases is similar to that shown in FIG. 7. Therefore, the detailed description will be omitted.

As described above, in the second embodiment, the PWM signals Vpwmp and Vpwmn are set according to the voltage step-up signal Vp and the voltage step-down signal Vm. Therefore, it is possible to more quickly return the output voltage Vout to the original value observed before the load Rload varies.

### Third Embodiment

The first and the second embodiments describe a step-down DC-DC converter which generates the output voltage Vout lower than the input voltage Vin. On the other hand, a third embodiment describes a step-up DC-DC converter which generates the output voltage Vout higher than the input voltage Vin.

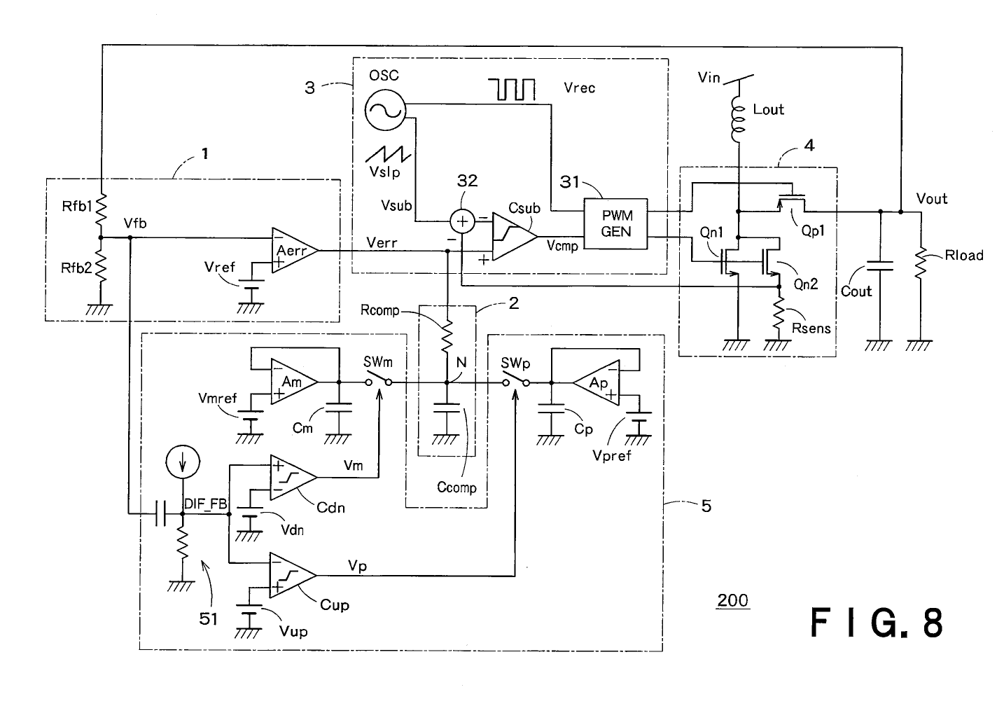

FIG. 8 is a circuit diagram of a DC-DC converter 200 according to the third embodiment. In FIG. 8, the same reference numerals and symbols are given to the same elements as those shown in FIG. 1. Hereinafter, the difference will be mainly described.

The switching module 4 shown in FIG. 8 includes a PMOS transistor Qp1 and an NMOS transistor Qn1 which are cascaded between the output terminal of the DC-DC converter 200 and an earth terminal, and also includes an NMOS transistor Qn2 and a resistor Rsens which are connected in parallel with the transistor Qn1. A coil Lout is connected between the input power terminal and a connection node between the transistors Qp1 and Qn1. Since an input voltage Vin is connected to a load Rload through the coil Lout, an output voltage Vout higher than the input voltage Vin can be supplied to the load Rload.

An outline of the operation of the DC-DC converter 200 is as follows. When a resistance of the load Rload slightly increases, the current flowing through the load Rload decreases. Then, the output voltage Vout becomes higher than a desired voltage, and the feedback voltage Vfb rises. Therefore, the error voltage Verr lowers. As a result, the duty ratio of the PWM signals Vpwmp and Vpwmn decreases and the time period in which the transistor Qp1 is on increases. Therefore, the output voltage Vout lowers and stabilizes at a desired voltage.

On the other hand, when the resistance of the load Rload slightly decreases, the current flowing through the load Rload increases. Then, the output voltage Vout becomes lower than the desired voltage, and the feedback voltage Vfb lowers. Therefore, the error voltage Verr rises. As a result, the duty ratio of the PWM signals Vpwmp and Vpwmn increases and the time period in which the transistor Qp1 is on increases. Therefore, the output voltage Vout rises and stabilizes at the desired voltage. By the feedback operation as described above, the DC-DC converter 200 can generate a constant output voltage Vout even if the load Rload varies somewhat.

Because the DC-DC converter 200 shown in FIG. 8 also includes the error voltage adjuster 5, by the same operation principle as that in the first embodiment, even when the load Rload varies largely, it is possible to quickly return the output voltage Vout to the desired value observed before the load Rload varies.

In the DC-DC converter 200 shown in FIG. 8, in the same manner as in FIG. 6, the PWM signals Vpwmp and Vpwmn may be set according to the voltage step-up signal Vp and the voltage step-down signal Vm.

The DC-DC converters shown in FIG. 1 and the like are only an example, and various modifications are possible. For example, at least a part of the MOS transistors may be formed using other semiconductor elements such as a bipolar transistor and a Bi-CMOS. The conductivity types of the transistors may be reversed and a DC-DC converter in which the connection positions of the power terminal and the earth terminal are reversed according to the conductivity types may be formed. Also in this case, the basic operation principle is the same as described above.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A semiconductor integrated circuit device for a DC-DC converter configured to convert an input voltage to an output voltage by controlling a voltage supplied to a load according to a Pulse Width Modulation (PWM) signal, and to output the output voltage from an output terminal,
the device comprising:
an error voltage generator configured to generate an error voltage indicative of a difference between a feedback voltage corresponding to the output voltage and a predetermined reference voltage;
a phase compensating module configured to compensate a phase of the error voltage;
a controller configured to generate the PWM signal whose duty ratio depends on the error voltage and on a current flowing through the load connected to the output terminal; and
an error voltage adjuster configured to adjust the error voltage based on a gradient of the feedback voltage.

2. The device of claim 1, wherein the error voltage adjuster is configured to adjust the error voltage to suppress a variation of the output voltage when the gradient of the feedback voltage is equal to or less than a first threshold and when the gradient of the feedback voltage is equal to or more than a second threshold higher than the first threshold.

3. The device of claim 1, wherein the error voltage adjuster comprises:
a differential detector configured to detect the gradient of the feedback voltage;
a voltage step-up module configured to raise the error voltage when the gradient is equal to or less than a first threshold; and
a voltage step-down module configured to drop the error voltage when the gradient is equal to or more than a second threshold higher than the first threshold.

4. The device of claim 3, wherein
the phase compensating module comprises:
a phase compensating resistance, one end of which is connected to an output of the error voltage generator; and
a phase compensating capacitor connected between the other end of the phase compensating resistance and an earth terminal,
the voltage step-up module comprises:
a first comparator configured to compare the gradient of the feedback voltage with the first threshold;
a first switch comprising a first terminal and a second terminal, the first switch being controlled by a comparison result of the first comparator, the first terminal of the first switch being connected to a connection node between the phase compensating resistance and the phase compensating capacitor;
a first capacitor connected between the second terminal of the first switch and the earth terminal; and
a first amplifier, a reference voltage for raising being inputted to a positive input terminal of the first amplifier, a negative input terminal and an output terminal of the first amplifier being connected to the second terminal of the first switch,
the voltage step-down module comprises:
a second comparator configured to compare the gradient of the feedback voltage with the second threshold;
a second switch comprising a first terminal and a second terminal, the second switch being controlled by a comparison result of the second comparator, the first terminal of the second switch being connected to a connection node between the phase compensating resistance and the phase compensating capacitor;
a second capacitor connected between the second terminal of the second switch and the earth terminal; and
a second amplifier, a reference voltage for dropping being inputted to a positive input terminal of the second amplifier, a negative input terminal and an output terminal of the second amplifier being connected to the second terminal of the second switch.

5. The device of claim 1, wherein the controller is configured to control the PWM signal based on the gradient of the feedback voltage.

6. The device of claim 5, wherein the controller is configured to control the PWM signal to suppress a variation of the output voltage when the gradient of the feedback voltage is equal to or less than a third threshold and when the gradient of the feedback voltage is equal to or more than a fourth threshold higher than the third threshold.

7. The device of claim 1 further comprising a switching module configured to control the voltage supplied to the load according to the PWM signal.

8. A DC-DC converter configured to configured to convert an input voltage to an output voltage by controlling a voltage supplied to a load according to a Pulse Width Modulation (PWM) signal, and to output the output voltage from an output terminal, the converter comprising:
an inductor comprising a first terminal and a second terminal, the first terminal being connected to the output terminal;
an output capacitor connected between the output terminal and an earth terminal;
an error voltage generator configured to generate an error voltage indicative of a difference between a feedback voltage corresponding to the output voltage and a predetermined reference voltage;
a phase compensating module configured to compensate a phase of the error voltage;
a controller configured to generate the PWM signal whose duty ratio depends on the error voltage and on a current flowing through the load connected to the output terminal; and
an error voltage adjuster configured to adjust the error voltage based on a gradient of the feedback voltage,
wherein whether the input voltage is supplied to the second terminal of the inductor is switched according to the PWM signal.

9. The converter of claim 8, wherein the error voltage adjuster is configured to adjust the error voltage to suppress a variation of the output voltage when the gradient of the feedback voltage is equal to or less than a first threshold and when the gradient of the feedback voltage is equal to or more than a second threshold higher than the first threshold.

10. The converter of claim 8, wherein the error voltage adjuster comprises:
a differential detector configured to detect the gradient of the feedback voltage;
a voltage step-up module configured to raise the error voltage when the gradient is equal to or less than a first threshold; and
a voltage step-down module configured to drop the error voltage when the gradient is equal to or more than a second threshold higher than the first threshold.

11. The converter of claim 10, wherein
the phase compensating module comprises:
a phase compensating resistance, one end of which is connected to an output of the error voltage generator; and
a phase compensating capacitor connected between the other end of the phase compensating resistance and an earth terminal,
the voltage step-up module comprises:
a first comparator configured to compare the gradient of the feedback voltage with the first threshold;
a first switch comprising a first terminal and a second terminal, the first switch being controlled by a comparison result of the first comparator, the first terminal of the first switch being connected to a connection node between the phase compensating resistance and the phase compensating capacitor;
a first capacitor connected between the second terminal of the first switch and the earth terminal; and
a first amplifier, a reference voltage for raising being inputted to a positive input terminal of the first amplifier, a negative input terminal and an output terminal of the first amplifier being connected to the second terminal of the first switch,
the voltage step-down module comprises:
a second comparator configured to compare the gradient of the feedback voltage with the second threshold;
a second switch comprising a first terminal and a second terminal, the second switch being controlled by a comparison result of the second comparator, the first terminal of the second switch being connected to a connection node between the phase compensating resistance and the phase compensating capacitor;
a second capacitor connected between the second terminal of the second switch and the earth terminal; and
a second amplifier, a reference voltage for dropping being inputted to a positive input terminal of the second amplifier, a negative input terminal and an output terminal of the second amplifier being connected to the second terminal of the second switch.

12. The converter of claim 8, wherein the controller is configured to control the PWM signal based on the gradient of the feedback voltage.

13. The converter of claim 12, wherein the controller is configured to control the PWM signal to suppress a variation of the output voltage when the gradient of the feedback voltage is equal to or less than a third threshold and when the gradient of the feedback voltage is equal to or more than a fourth threshold higher than the third threshold.

14. The converter of claim 8 further comprising a switching module configured to control the voltage supplied to the load according to the PWM signal.

15. A DC-DC converter configured to configured to convert an input voltage to an output voltage by controlling a voltage supplied to a load according to a Pulse Width Modulation (PWM) signal, and to output the output voltage from an output terminal, the DC-DC converter comprising:
an inductor comprising a first terminal and a second terminal, the first terminal being connected to a power supply terminal which supplies the input voltage;
an output capacitor connected between the output terminal and an earth terminal;
an error voltage generator configured to generate an error voltage indicative of a difference between a feedback voltage corresponding to the output voltage and a predetermined reference voltage;
a phase compensating module configured to compensate a phase of the error voltage;
a controller configured to generate the PWM signal whose duty ratio depends on the error voltage and on a current flowing through the load connected to the output terminal; and
an error voltage adjuster configured to adjust the error voltage based on a gradient of the feedback voltage,
wherein whether a voltage of the second terminal of the inductor is supplied to the output terminal is switched according to the PWM signal.

16. The converter of claim 15, wherein the error voltage adjuster is configured to adjust the error voltage to suppress a variation of the output voltage when the gradient of the feedback voltage is equal to or less than a first threshold and when the gradient of the feedback voltage is equal to or more than a second threshold higher than the first threshold.

17. The converter of claim 15, wherein the error voltage adjuster comprises:
a differential detector configured to detect the gradient of the feedback voltage;
a voltage step-up module configured to raise the error voltage when the gradient is equal to or less than a first threshold; and
a voltage step-down module configured to drop the error voltage when the gradient is equal to or more than a second threshold higher than the second threshold.

18. The converter of claim 17, wherein
the phase compensating module comprises:
a phase compensating resistance one end of which is connected to an output of the error voltage generator; and
a phase compensating capacitor connected between the other end of the phase compensating resistance and an earth terminal,
the voltage step-up module comprises:
a first comparator configured to compare the gradient of the feedback voltage with the first threshold;
a first switch comprising a first terminal and a second terminal, the first switch being controlled by a comparison result of the first comparator, the first terminal of the first switch being connected to a connection node between the phase compensating resistance and the phase compensating capacitor;
a first capacitor connected between the second terminal of the first switch and the earth terminal; and
a first amplifier, a reference voltage for raising being inputted to a positive input terminal of the first amplifier, a negative input terminal and an output terminal of the first amplifier being connected to the second terminal of the first switch,
the voltage step-down module comprises:
a second comparator configured to compare the gradient of the feedback voltage with the second threshold;
a second switch comprising a first terminal and a second terminal, the second switch being controlled by a comparison result of the second comparator, the first terminal of the second switch being connected to a connection node between the phase compensating resistance and the phase compensating capacitor;
a second capacitor connected between the second terminal of the second switch and the earth terminal; and
a second amplifier, a reference voltage for dropping being inputted to a positive input terminal of the second amplifier, a negative input terminal and an output terminal of the second amplifier being connected to the second terminal of the second switch.

19. The converter of claim 15, wherein the controller is configured to control the PWM signal based on the gradient of the feedback voltage.

20. The converter of claim 19, wherein the controller is configured to control the PWM signal to suppress a variation of the output voltage when the gradient of the feedback voltage is equal to or less than a third threshold and when the gradient of the feedback voltage is equal to or more than a fourth threshold higher than the third threshold.
